(19) United States
(12) Patent Application Publication
(10) Pub. No.: US 2012/0229384 A1
(43) Pub. Date: Sep. 13, 2012

(54) DISPLAY DEVICE WITH LOCATION DETECTION FUNCTION AND INPUT LOCATION DETECTION SYSTEM

(75) Inventors: Noriyuki Nakane, Osaka (JP); Nobuaki Takahashi, Osaka (JP)

(73) Assignee: SHARP KABUSHIKI KAISHA, Osaka (JP)

(21) Appl. No.: 13/513,165

(22) PCT Filed: Nov. 12, 2010
(86) PCT No.: PCT/JP2010/070227

§ 371 Date: May 31, 2012

(30) Foreign Application Priority Data
Dec. 3, 2009 (JP) 2009-275525

(51) Int. Cl. G06F 3/033

(52) U.S. Cl. 345/158

(57) ABSTRACT

An input position detection system (1) according to the present invention includes a laser pointer (50) that emits infrared light, and a liquid crystal display device (10) that detects a position of an input from the input pointer (50) by detecting the infrared light. The liquid crystal display device (10) includes optical sensor elements (30), a received light intensity calculation circuit (31), a coordinate extracting circuit (32), a combining and calculating circuit (33), an input signal calculation circuit (35), and the like. The combining and calculating circuit (33) calculates the intensities of received light at respective coordinate positions on the basis of the information obtained by the coordinate extracting circuit (32) and the received light intensity calculation circuit (31). The input signal calculation circuit (35) calculates a distance of the laser pointer (50) from an image display surface, and detects the three-dimensional position of the laser pointer on the basis of the received light intensity information. The input position detection system thus handles three-dimensional pointing with a higher degree of accuracy.

### TECHNICAL FIELD

The present invention relates to a display device having a position detection function, which is capable of detecting a position of an input from the outside, and to an input position detection system.

### BACKGROUND ART

Flat panel display devices such as liquid crystal display devices have advantageous features including thin-profile, light weight, and low power consumption, and as a result of the technological development for improving a display performance such as a color display, high resolution, and a video capability, they are now used in a wide variety of electronic devices such as mobile phones, PDAs, DVD players, portable gaming devices, laptop computers, PC monitors, and televisions.

Against this background, a liquid crystal display device (display device with built-in optical sensors) in which each one of pixels (or one pixel in each set of RGB) in an image display region is provided with an optical sensor element has been developed in recent years. Patent Document 1, for example, discloses a liquid crystal display device in which optical sensor elements made of photodiodes are provided in respective pixel regions. By providing each pixel with the optical sensor element as described above, it becomes possible to achieve an area sensor function (specifically, a scanning function, a touch panel function, or the like) in a general liquid crystal display device. That is, the optical sensor elements provided in the display device serve as an area sensor, thereby achieving a display device having a position detection function.

### RELATED ART DOCUMENTS

### Patent Documents

Patent Document 1: Japanese Patent Application Laid-Open Publication No. 2006-18219 (Publication date: Jan. 11, 2006)

Patent Document 2: Japanese Patent Application Laid-Open Publication No. H7-104922 (Publication date: Apr. 21, 1995)

### SUMMARY OF THE INVENTION

### Problems to be Solved by the Invention

Recently, an image display device that is capable of stereoscopic display (3D display) has been disclosed. In performing the stereoscopic display by the above-mentioned display device having a position detection function, if the display device is capable of pointing a three-dimensional position in a stereoscopic image on a display, the range of application of such a display device can be widened.

However, the current display device with built-in optical sensors is not capable of such a three-dimensional position detection. That is because the currently available display device with built-in optical sensors is typically configured to detect a touch position on a surface of the device in a planar manner (two-dimensionally) as an input position, and a device that allows for remote pointing with a laser pointer or the like from a position having some distance from the surface of the device is not yet available.

As described above, the current display device with built-in optical sensors is not capable of detecting a distance from the device surface, and therefore cannot perform the three-dimensional position detection.

Patent Document 2 discloses a non-contact pointing device that can perform three-dimensional position detection by detecting the intensity of electromagnetic wave. FIG. 16 shows an example of a configuration of the pointing device disclosed in Patent Document 2.

A pointing device 100 shown in FIG. 16 includes a main unit 110 and an input pointer (operating unit) 120. The main unit 110 includes a display unit 105 that displays images, a plurality of detectors 101 to 104 disposed around the display unit 105 that detects the intensity of electromagnetic wave, and a spatial position analyzing unit 106 that analyzes the position of the input pointer 120 in space based on the intensity of electromagnetic wave detected by the detectors 101 to 104. The input pointer 120 is provided with an electromagnetic wave generating unit (not shown) that sends information of the input position to the main body 110.

Patent Document 2 describes that, with this configuration, electromagnetic wave sent from the input pointer 120 is detected by the detectors 101 to 104 on the main body 110, and based on data obtained by the respective detectors, the spatial position analyzing unit 106 performs a calculation, thereby detecting the three-dimensional position of the input pointer 120.

However, such a configuration has problems in that it requires a plurality of outputs from detectors to be compared and normalized, which creates a need for a plurality of detectors, and that if the number of detectors is not sufficient, the position detection accuracy is lowered. Also, a multi-point input using a plurality of input pointers cannot be performed. Further, because the detectors are disposed outside of the display unit, it is not possible to detect the input position of the input pointer in relation to the position of a displayed image, which may cause a discrepancy between the position of a displayed image and the input position.

The present invention was made in view of the above-mentioned problems, and is aiming at providing a display device having a position detection function and an input position detection system, which allow for three-dimensional pointing with a higher degree of accuracy.

### Means for Solving the Problems

In order to solve the above-mentioned problems, a display device according to the present invention that has a position detection function capable of detecting light output from an input pointer and thereby detecting an input position of the input pointer includes: a plurality of optical sensor elements disposed in a matrix so as to correspond to an image display surface of the display device; a plane coordinate detecting unit that detects positions on an array of the respective optical sensor elements disposed in a matrix where an input from the input pointer was received; a received light intensity detecting unit that detects intensities of light received by the optical sensor elements; a coordinate and intensity combining unit that derives the intensities of received light at respective coordinate positions by combining the positions on a coordinate plane where the input was received, which were obtained by the plane coordinate detecting unit, and the intensities of light received on the coordinate plane, which were obtained by the received light intensity detecting unit; and a input position detecting unit that “detects the three-dimensional input position of the input pointer” by calculating a distance of the input pointer from the image display surface based on the light intensity information obtained by the coordinate and intensity combining unit.

“Detects the three-dimensional input position of the input pointer” means detecting the input position of the input pointer on the plane where the optical sensor elements are disposed in a matrix, and detecting how far the input pointer is located from the plane, i.e., a distance between the input pointer and the optical sensor elements. That is, it means detecting the position that is pointed by the input pointer in a space coordinate system (XYZ space coordinate system, for example).

In the above-mentioned configuration, the coordinate and intensity combining unit calculates the intensities of received light at respective coordinate positions by combining the positions on the coordinate plane where the input was received, which were obtained by the plane coordinate detecting unit, and the intensities of the light received on the coordinate plane, which were obtained by the received light intensity detecting unit, and the input position detecting unit calculates a distance of the input pointer from the image display surface based on the light intensity information obtained by the coordinate and intensity combining unit. This way, not only the position on the coordinate plane, which is pointed by the input pointer, but also the distance between the input pointer and the image display surface can be detected, which makes it possible to detect the input position of the input pointer three-dimensionally.

In the above-mentioned configuration, an input position is detected by an area sensor that is made of the respective optical sensor elements disposed in a matrix so as to correspond to the image display surface. This makes it possible to detect the three-dimensional input position in relation to the position of a displayed image, and as a result, highly accurate three-dimensional pointing can be performed.

### Effects of the Invention

The display device according to the present invention detects an input position three-dimensionally by using an area sensor constituted of the respective optical sensor elements disposed in a matrix so as to correspond to the image display surface, and thus allows for three-dimensional pointing with a higher degree of accuracy.

The input position detection system according to the present invention is provided with the display device of the present invention, and therefore allows for the three-dimensional pointing with a higher degree of accuracy.

### BRIEF DESCRIPTION OF THE DRAWINGS

FIG. 1 is a block diagram that shows a configuration for detecting a position in an input position detection system illustrated in FIG. 2.

FIG. 2 is a schematic diagram of a configuration of an input position detection system according to Embodiment 1 of the present invention.

FIG. 3 is a block diagram showing a configuration of a liquid crystal display device included in the input position detection system illustrated in FIG. 2.

FIG. 4 is a schematic diagram of sequential scanning for optical sensor elements that are disposed in a matrix in a liquid crystal panel of the liquid crystal display device shown in FIG. 3.

FIG. 5 is a block diagram showing a configuration of a laser pointer (input pointer) included in the input position detection system illustrated in FIG. 2.

FIG. 6 is a schematic diagram showing three-dimensional position detection in the input position detection system illustrated in FIG. 2.

FIG. 7 is a schematic diagram for explaining a method of detecting a tilt angle of the laser pointer (input pointer) in the input position detection system illustrated in FIG. 2.

FIG. 8 is a flowchart showing a process flow of the three-dimensional position detection in the input position detection system illustrated in FIG. 2.

FIG. 9 is a block diagram showing a modification example of the input position detection system illustrated in FIG. 1.

FIG. 10 is a schematic diagram showing three-dimensional position detection in an input position detection system according to Embodiment 2 of the present invention.

FIG. 11 is a block diagram showing a configuration of the input position detection system according to Embodiment 2 of the present invention.

FIG. 12(a) is a flowchart showing a process flow of the three-dimensional position detection for a single point input in the input position detection system illustrated in FIG. 10.

FIG. 12(b) is a flowchart showing a process flow of the three-dimensional position detection for a multi-point input in the input position detection system illustrated in FIG. 10.

FIG. 13(a) is a schematic diagram showing a position detection scheme in the input position detection system illustrated in FIG. 10 when a single point input is performed. FIG. 13(b) is a schematic diagram for explaining a method of detecting an input position in the input position detection system illustrated in FIG. 10 when a single point input is performed.

FIG. 14(a) is a schematic diagram showing a position detection scheme in the input position detection system illustrated in FIG. 10 when a multi-point input is performed. FIG. 14(b) is a schematic diagram for explaining a method of detecting input positions in the input position detection system illustrated in FIG. 10 when a multi-point input is performed.

FIG. 15 is a schematic diagram for explaining a method of detecting positional changes of a plurality of input pointers in the input position detection system illustrated in FIG. 11.

FIG. 16 is a schematic diagram showing a configuration of a conventional non-contact input position detection system (pointing device).

### DETAILED DESCRIPTION OF EMBODIMENTS

### Embodiment 1

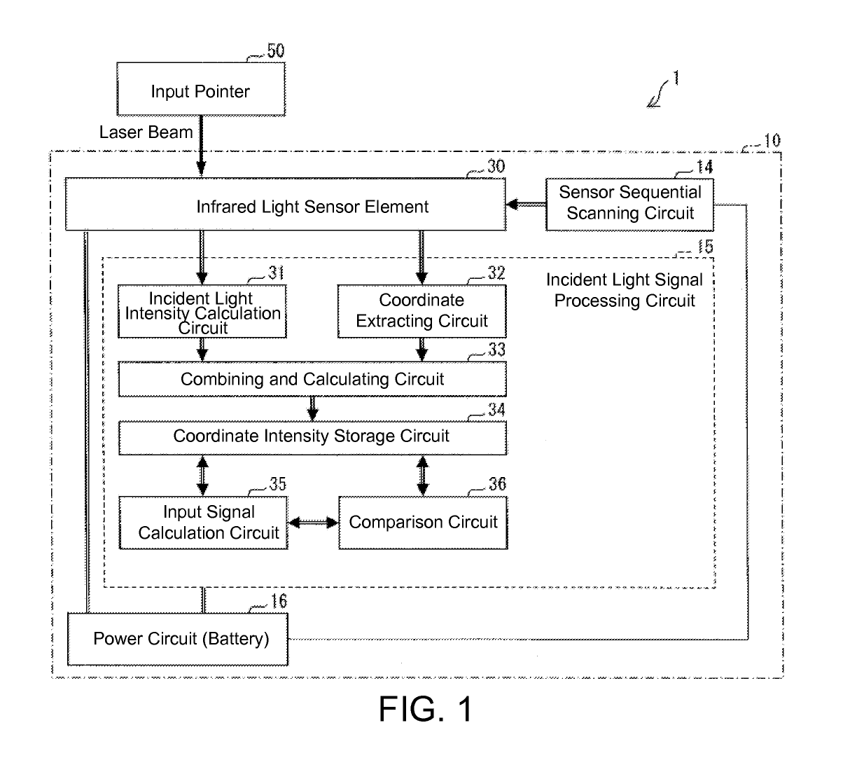

Below, Embodiment 1 of the present invention will be described with reference to FIGS. 1 to 9, but the present invention is not limited to the following embodiment.

In this embodiment, a liquid crystal display device that has optical sensor elements in the pixel regions thereof and thereby has an area sensor function (position detection function) will be explained as an example of a display device of the present invention. In this embodiment, a non-contact input position detection system that includes the liquid crystal display device and a laser pointer that performs an input to the liquid crystal display device will also be explained.

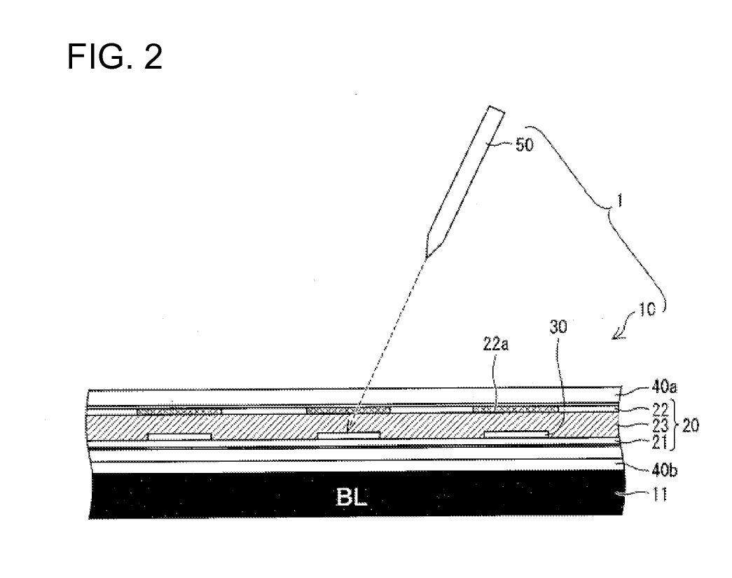

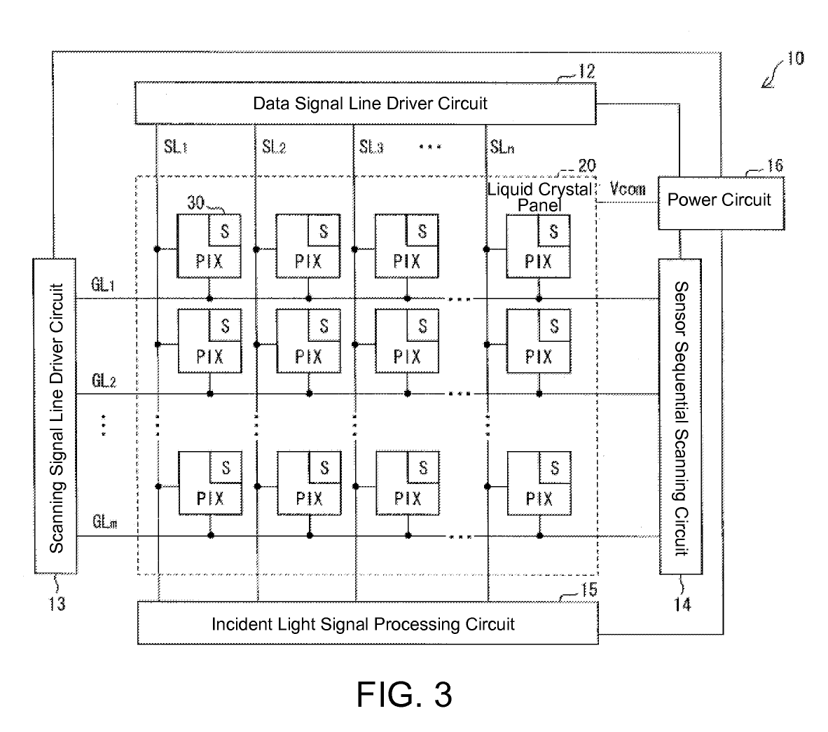

FIG. 2 shows a configuration of an input position detection system 1 constituted of a liquid crystal display device 10 (display device) and a laser pointer (input pointer) 50. FIG. 3 shows a configuration of the liquid crystal display device 10 of this embodiment having the area sensor function (also simply referred to as “liquid crystal display device 10”). In FIG. 2, a cross-sectional configuration of the liquid crystal display device 10 is schematically shown. In FIG. 3, a configuration of an image display region of the liquid crystal display device 10 is schematically shown in a plan view.

As shown in FIG. 2, the liquid crystal display device 10 of this embodiment includes a liquid crystal panel 20 and a backlight 11 that is disposed on the rear surface side of the liquid crystal panel 20 and that illuminates the liquid crystal panel.

The liquid crystal panel 20 includes an active matrix substrate 21 having a plurality of pixels arranged in a matrix and an opposite substrate 22 disposed so as to face the active matrix substrate. Further, a liquid crystal layer 23, which is a display medium, is sandwiched by these two substrates.

On outer surfaces of the liquid crystal panel 20, a front side polarizing plate 40a and a rear side polarizing plate 40b are respectively provided so as to sandwich the liquid crystal panel 20.

The respective polarizing plates 40a and 40b serve as polarizers. When a vertically aligned liquid crystal material is sealed in the liquid crystal layer, for example, by disposing the front side polarizing plate 40a and the rear side polarizing plate 40b such that the respective polarizing directions are in the crossed Nicols state, a normally black mode liquid crystal display device can be obtained.

The active matrix substrate 21 is provided with TFTs (not shown), which are switching elements that drive the respective pixels, an alignment film (not shown), optical sensor elements 30, and the like.

Although not shown in the figure, a color filter layer, an opposite electrode, an alignment film, and the like are formed in the opposite substrate 22. The color filter layer includes colored sections of respective colors of red (R), green (G), and blue (b), and a black matrix. In the opposite substrate 22, optical filters 22a that block visible light and selectively transmit infrared light are provided at positions that correspond to regions where the optical sensor elements 30 are disposed.

The backlight 11 is provided for emitting light to the liquid crystal panel 20. In this embodiment, the backlight 11 uses a white LED as a light source, and emits white light to the liquid crystal panel 20.

The laser pointer 50 is provided for performing an input to a prescribed point on the image display surface of the liquid crystal display device 10. The laser pointer 50 emits infrared light of a prescribed intensity from a tip thereof.

As described above, in the liquid crystal display device 10 of this embodiment, the optical sensor elements 30 are provided in the respective pixel regions for detecting infrared light, thereby achieving an area sensor function. The optical sensor elements 30 detect infrared light emitted from the tip of the laser pointer 50 to a specific point, which allows a user to input information into the liquid crystal display device 10, and to execute a target operation.

Next, a specific configuration of the optical sensor elements 30 will be explained below.

The optical sensor elements 30 are photoelectric conversion elements that detect an amount of received light (intensity of received light) by producing a current in accordance with the intensity of received light. The optical sensor elements 30 are made of photodiodes or phototransistors. The TFTs and the optical sensor elements 30 may be formed monolithically on the active matrix substrate 21 by the substantially same process. That is, some of the constituting members of the optical sensor elements 30 may be formed simultaneously with some of the constituting members of the TFTs. A method of forming such an optical sensor element can be the same as that in a conventional method of manufacturing a liquid crystal display device with built-in optical sensor elements.

As shown in FIG. 2, in the opposite substrate 22, the optical filters 22a that block visible light are provided at positions that correspond to regions where the optical sensor elements 30 are disposed. These optical filters 22a are provided in the color filter layer, and respectively have a laminated structure of a red color filter and a blue color filter, which are included in the colored sections of the color filter layer. This way, among components of light received by the optical sensor elements 30, a visible light component can be blocked. By having such optical filters 22a, the optical sensor elements 30 can selectively receive the infrared light component extracted from light received by the image display surface of the liquid crystal panel 20. Thus, the optical sensor elements 30 can detect the intensity of infrared light.

As described above, the optical sensor element 30 and the optical filter 22a are combined so as to detect the intensity of infrared light, and therefore, this combination may also be referred to as an infrared sensor element.

The optical filter 22a is not limited to the above-mentioned filter, and any filters may be used as long as they have functions of blocking all components (visible light and the like, for example) but the infrared light among the components of light received by the optical sensor elements 30, and selectively transmitting the infrared light. That is, as the optical filter 22a, known optical filters that selectively transmit infrared light can be used. In this embodiment, the optical filters 22a are incorporated in the color filter layer, but the present invention is not limited to such a configuration, and optical filters that selectively transmit infrared light may be directly laminated on light-receiving sections of the optical sensor elements 30.

When the optical sensor elements have a function of selectively transmitting infrared light, the optical filters 22a are not necessarily required. As the optical sensor elements that have a function of selectively transmitting infrared light, known optical sensor elements can be employed.

The light emitted from the laser pointer to make an input is not limited to infrared light, and may be visible light. In this case, optical sensor elements that can detect the intensity of light having the corresponding wavelength (that is, optical sensor elements that can detect the intensity of visible light) are used. As the optical sensor elements that can detect the intensity of visible light, known optical sensor elements can be employed.

Next, a configuration of the liquid crystal panel 20 in the liquid crystal display device 10 in a plan view will be explained with reference to FIG. 3.

As shown in FIG. 3, the liquid crystal panel 20 includes a plurality of pixels PIX . . . that are arranged in a matrix. The liquid crystal panel 20 further includes n number of data signal lines SL1 to SLn and m number of scanning signal lines GL1 to GLm that intersect with the respective data signal lines SL1 to SLn. The pixels PIX are provided near respective intersections of the data signal lines SL1 to SLn and the scanning signal lines GL1 to GLm, respectively. Each of the pixels PIX . . . is formed in a section that is enclosed by two adjacent data signal lines SLi and SLi+1 and two adjacent scanning signal lines GLj and GLj+1.

As shown in FIG. 3, the liquid crystal display device 10 is provided with a data signal line driver circuit 12 that supplies data signals to the respective pixels PIX . . . through the data signal lines SL1 to SLn, and a scanning signal line driver circuit 13 that supplies a scanning signal to the respective pixels PIX . . . through the scanning signal lines GL1 to GLm. This way, an image can be displayed in accordance with image signals that represent display states of the respective pixels PIX . . . .

The liquid crystal panel 20 further includes optical sensor elements (S) 30 . . . that are provided for the respective pixels PIX . . . . That is, in the manner similar to the respective pixels PIX . . . , the optical sensor elements (S) 30 . . . are arranged in a matrix in the image display region.

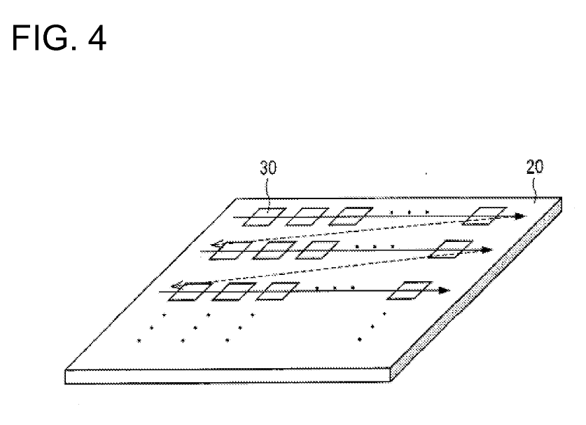

The liquid crystal display device 10 further includes a sensor sequential scanning circuit 14, a received light signal processing circuit 15, and a power circuit 16. The sensor sequential scanning circuit 14 sequentially selects the optical sensor elements 30 . . . arranged in a matrix at a prescribed interval through the respective scanning signal lines GL1 to GLm (see FIG. 4). The received light signal processing circuit 15 reads out received light signals through the respective data signal lines SL1 to SLn from the optical sensor elements 30 that are sequentially selected by the sensor sequential scanning circuit 14, and processes the signals that have been read out. The power circuit 16 supplies power to the respective circuits 12, 13, 14, and 15, and supplies a common potential Vcom to the opposite substrate 22 of the liquid crystal panel 20.

By having this configuration, the liquid crystal display device 10 of this embodiment can detect the intensity of infrared light by sequentially scanning the optical sensor elements 30 provided in the respective pixels, and is therefore provided with a three-dimensional position detection function, which allows it to detect the position of the laser pointer 50 in prescribed space above the image display surface.

In the present invention, the optical sensor elements may not necessarily be provided for the respective pixels. The optical sensor elements may be provided for the respective one color pixels in the sets of three color pixels of R, G, and B, for example.

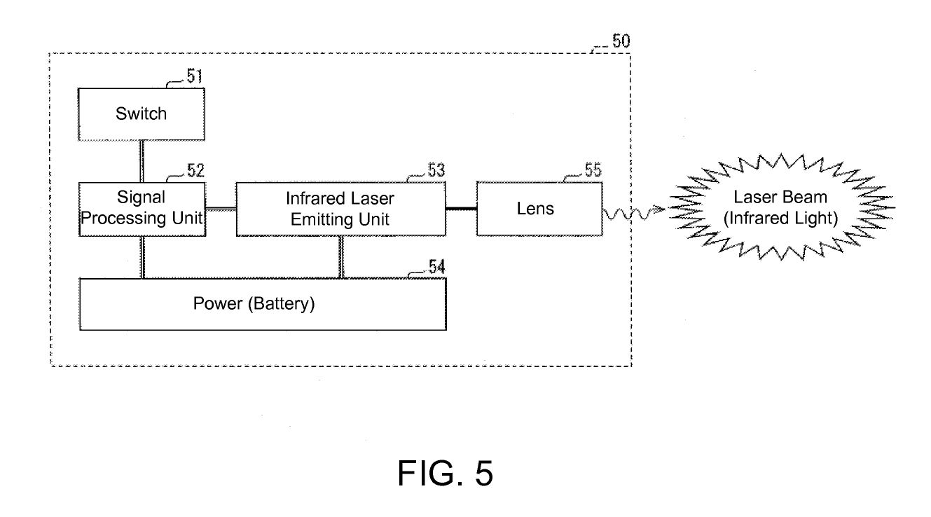

Next, an internal configuration of the laser pointer 50 will be explained with reference to FIG. 5.

As shown in FIG. 5, the laser pointer 50 includes a switch 51, a signal processing unit 52, an infrared laser beam emitting unit 53 (infrared light outputting unit), a power source (battery) 54, a lens 55, and the like.

In this laser pointer 50, upon detecting the switch 51 being turned on, the signal processing unit 52 instructs the infrared laser beam emitting unit 53 to output an infrared laser beam of a prescribed intensity. The laser beam (infrared light) emitted from the infrared laser beam emitting unit 53 is diffused at prescribed angles by the lens 55. However, the lens 55 is not an essential component of the present invention, and therefore may not be provided. The power source (battery) 54 supplies power to the signal processing 52 and the infrared laser beam emitting unit 53.

Next, a configuration for performing the three-dimensional position detection in the input position detection system 1 of this embodiment will be explained with reference to FIG. 1.

As described above, the respective optical sensor elements 30 (infrared light sensor elements) provided in the liquid crystal panel 20 are sequentially selected by the sensor sequential scanning circuit 14 through the respective scanning signal lines GL1 to GLm. The received light signal processing circuit 15 reads out received light signals through the respective data signal lines SL1 to SLn from the optical sensor elements 30 that are sequentially selected by the sensor sequential scanning circuit 14, and performs various processes to the signals that have been read out. The power circuit 16 supplies power to the optical sensor elements 30, the sensor sequential scanning circuit 14, and the received light signal processing circuit 15, respectively. The power circuit 16 may be a battery.

The received light signal processing circuit 15 includes a received light intensity calculation circuit 31 (received light intensity detecting unit), a coordinate extracting circuit 32 (plane coordinate detecting unit), a combining and calculating circuit 33 (coordinate and intensity combining unit), a coordinate intensity storage circuit 34, an input signal calculation circuit 35 (input position detecting unit), and a comparison circuit 36 (positional change calculating unit).

The received light intensity calculation circuit 31 derives intensities of infrared light that is emitted from the laser pointer 50 and that is received by the optical sensor elements 30, based on the received light signals (current values that correspond to the intensities of the received light) sent from the respective optical sensor elements 30.

The coordinate extracting circuit 32 extracts positions of the respective optical sensor elements 30 that are sequentially selected by the sensor sequential scanning circuit 14 on the matrix, i.e., respective sets of coordinates on the coordinate plane.

The combining and calculating circuit 33 combines the intensities of infrared light derived by the received light intensity calculation circuit 31 and the coordinate positions extracted by the coordinate extracting circuit 32, and derives intensities of received light at the respective coordinate positions, respectively.

The coordinate intensity storage circuit 34 obtains the intensities of the light received by the respective optical sensor elements 30, which are derived by the combining and calculating circuit 33, and stores the intensities of the received light at the respective coordinate positions.

The input signal calculation circuit 35 derives, based on the information stored in the coordinate intensity storage circuit 34, the coordinate position where the intensity of the received light reaches the peak and a level of the peak intensity. This calculation is performed every time a scan of the entire optical sensor elements 30 is conducted by the sensor sequential scanning circuit 14 (in every scan), and therefore, the coordinate position with the peak intensity and the level of the peak intensity are obtained in every scan. Thus, in every scan, information of the coordinate position with the peak intensity and the level of the peak intensity is temporarily stored in a memory (storage unit) of the coordinate intensity storage circuit 34.

The comparison circuit 36 compares information of the coordinate position with the peak intensity and the level of the peak intensity in the current scan, which is obtained by the input signal calculation circuit 35, with information of the coordinate position with the peak intensity and the level of the peak intensity in the previous scan (a scan immediately preceding the current scan), which is stored in the memory, and determines whether the three-dimensional position of the laser pointer 50 has been changed.

Next, a method of performing the three-dimensional position detection in the input position detection system 1 of this embodiment will be explained.

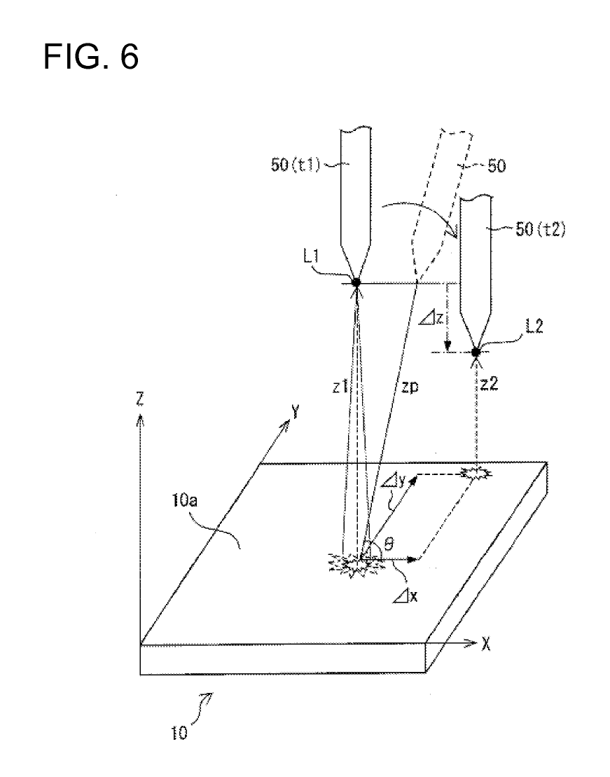

FIG. 6 is a schematic diagram of the input position detection system 1 performing the three-dimensional position detection. As shown in FIG. 6, in the input position detection system 1, the optical sensor elements 30 in the liquid crystal display device 10 detect a laser beam (infrared light) emitted from the laser pointer 50 that is remotely located from a surface 10a of the liquid crystal display device 10, thereby detecting the three-dimensional position of the laser pointer 50. That is, the input position detection system 1 is a non-contact position detection system.

FIG. 6 illustrates the liquid crystal display device 10 detecting a coordinate position in XYZ space, which is pointed by the laser pointer 50. In an example shown in FIG. 6, the laser beam from the input pointer 50 is oriented in the direction perpendicular to the surface 10a of the device.

As shown in FIG. 6, the XYZ space refers to a three-dimensional space defined by three coordinate axes of X axis, Y axis, and Z axis, which are orthogonal to each other. Specifically, when a point (a lower right corner in the example shown in FIG. 6) on the surface 10a (detection target surface) of the liquid crystal display device 10 is a point having the coordinates of (0, 0, 0), the horizontal direction is the X axis direction, the front and back direction is the Y axis direction, and the vertical direction is the Z axis direction. This way, the surface 10a of the liquid crystal display device 10 is represented by the XY plane with the Z coordinate of 0, and a distance (height) from the surface 10a is represented by a value of the Z coordinate.

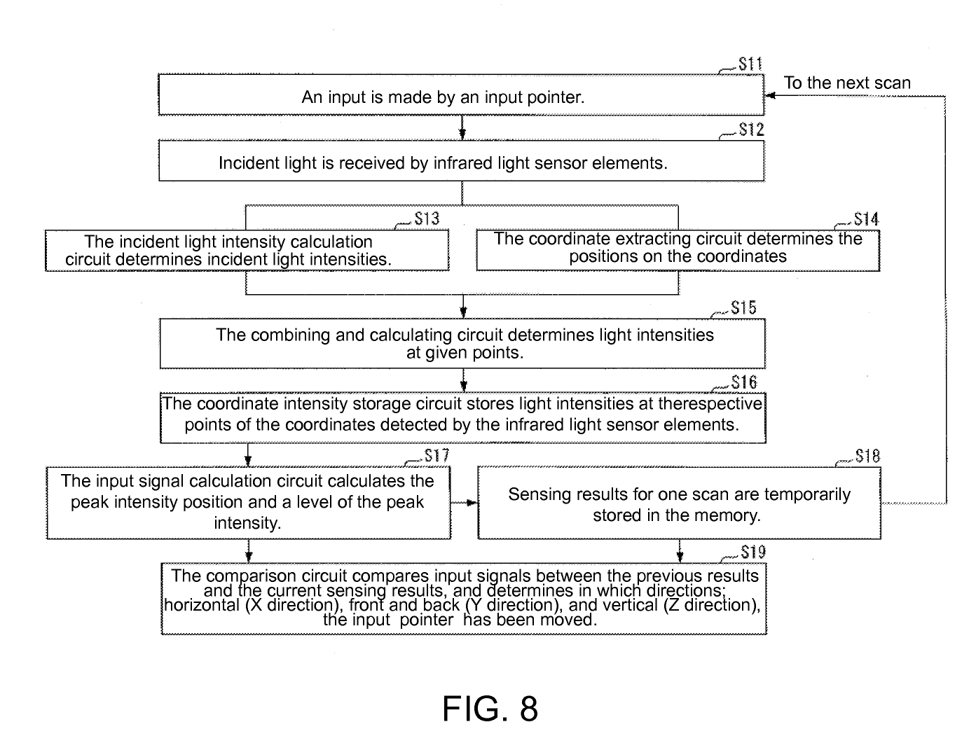

Below, a flow of a process of detecting the position of the laser pointer 50 at a point in time (t1) will be explained with reference to FIGS. 6 and 8.

As shown in FIG. 6, when a laser beam (infrared light) is emitted from the laser pointer 50 to the surface 10a of the liquid crystal display device 10 at a point in time (t1), the liquid crystal display device 10 receives an input from the laser pointer 50 (step S11) as shown in FIG. 8. At this time, in the liquid crystal display device 10, a sensing operation is performed by the respective optical sensor elements 30 (infrared light sensor elements) that are sequentially selected by the sensor sequential scanning circuit 14, and received light signals are generated based on an amount of infrared light that has been emitted (step S12). The received light signals of the respective optical sensor elements 30 obtained in each scan by the sensor sequential scanning circuit 14 are sent to the received light signal processing circuit 15 sequentially.

In the received light signal processing circuit 15, first, the received light intensity calculation circuit 31 derives the intensities of the received infrared light based on the received light signals that have been provided (step S13). Simultaneously with this step, the coordinate extracting circuit 32 determines coordinate positions from which the respective received light signals were sent in accordance with a scan by the sensor sequential scanning circuit 14 (step S14).

Subsequently, the combining and calculating circuit 33 combines the calculation results of the infrared intensities in the received light intensity calculation circuit 31 and the coordinate positions determined by the coordinate extracting circuit 32, and determines the intensities of infrared light at the respective coordinate positions (step S15). The coordinate intensity storage circuit 34 receives the intensities of light received by the respective optical sensor elements 30, which were derived by the combining and calculating circuit 33, and stores the received light intensities at the respective positions on the coordinate (step S16).

Thereafter, the input signal calculation circuit 35 derives, based on the information stored in the coordinate intensity storage circuit 34, a coordinate position with the peak light intensity and a level of the peak intensity (step S17), and defines the position on the XY coordinate plane having the peak intensity as the input position on the XY plane. A distance z1 of the laser pointer 50 (i.e., z coordinate of the laser pointer 50) from the surface 10a of the liquid crystal display device 10 is derived by referring to a reference table (reference data) in which distances from the detection target surface 10a are correlated to received light intensities at the respective distances. This table (reference data) is determined based on the intensity characteristics of the laser beam emitted from the laser pointer 50 and the responsivity characteristics of the optical sensor elements 30 in the liquid crystal display device 10.

The example described above is for a case where the laser pointer 50 is perpendicular to the surface 10a of the liquid crystal display device 10, or for a case where the laser pointer 50 is slightly tilted relative to the surface 10a, but “zp” can be regarded almost equal to “z1.” Here, “zp” is a distance between the tip of the laser pointer 50 and a portion on the device surface 10a where the laser beam is radiated (see FIG. 6).

As indicated with a broken line in FIG. 6, even when the laser pointer 50 is tilted relative to the surface 10a, by obtaining a relationship among the received light intensity, the tilt angle θ, and the distance zp in advance through measurement, the above-mentioned method (table and functions) can be employed to determine whether the position has been changed. In this case, the tilt angle θ needs to be calculated in advance. This way, the positional change can be detected even when the laser pointer 50 is tilted.

The method of calculating the distance z1 of the laser pointer 50 from the surface 10a is not limited to such, and the distance z1 can also be derived from the detected received light intensity by referring to a function and the like for the received light intensity and the distance z1 that has been stored in advance, for example.

The function for the received light intensity and the distance z1 is a function determined based on characteristics of the laser beam emitted from the laser pointer 50. This function can be obtained by recording changes in intensity levels detected by the optical sensor elements 30 when the distance z1 of the laser pointer 50 from the image display surface 10a is gradually changed, for example. The obtained function is stored in a memory of the received light signal processing circuit 15.

The respective processes from the step S1 through the step S17 are performed for every single scan conducted by the sensor sequential scanning circuit 14, and with the step S17, the three-dimensional position (L1) pointed by the laser pointer 50 at a given point in time (t1) is determined.

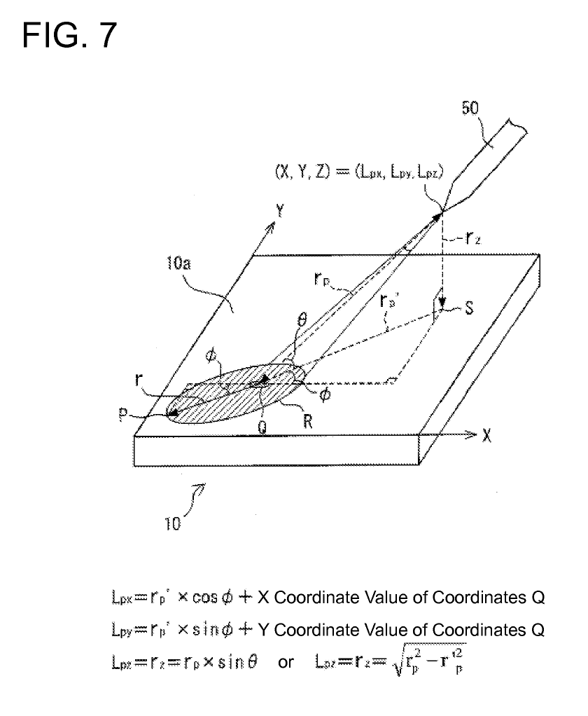

In this embodiment, it is also possible to detect the position of the tip of the laser pointer 50 as a three-dimensional input position. A detection method in this case will be explained below with reference to FIG. 7.

First, information of the position with the highest received light intensity (peak coordinates) Q and the received light intensity at the peak coordinates (peak intensity), which are obtained through sensing, is provided. Then, based on the reference data created in advance through measurement, a distance rₚ between the peak coordinates Q and the light emitting unit of the laser pointer 50 is derived.

Next, information of the number of points where the light intensity exceeds a prescribed threshold (information on the coordinates of the points in a region R indicated by hatching in the figure), which spread around the peak coordinates Q, is obtained. From this information, information of coordinates P, which is the furthest point from the peak coordinates Q among the points where the light intensity exceeds the prescribed threshold, is obtained, and further, a distance “r” between the coordinates P and the peak coordinates Q is derived. Here, it is understood that the angle of divergence of the laser beam emitted from the laser pointer 50 is already known.

From such information, an angle φ between the X axis and a line connecting the peak coordinates Q to the coordinates P, which is the furthest point among the points having the greater light intensity than the threshold, is derived.

When the position on the surface 10a that forms a vertical line with the tip of the laser pointer 50 is located at coordinates S, a distance rₚ′ between the coordinates Q and the coordinates S is derived based on a relational formula for the distance “r”, the peak intensity, and the distance rₚ′, which has been created in advance through measurement.

The tilt angle θ of the laser beam from the laser pointer 50 relative to the surface 10a (image display surface), the distance “r” between the peak coordinates Q and the coordinates P, which is the furthest point among the points having the greater light intensity than the prescribed threshold, and the received light intensity are correlated with one another. Based on this correlation, a function for the tilt angle θ is created in advance and stored in the received light signal processing circuit 15.

This allows the input signal calculation circuit 35 to derive the position of the tip of the laser pointer 50 according to the following formula based on the peak coordinates Q, the tilt angle θ, and the angle φ relative to the X axis, which have been obtained in the above-mentioned manner.

The three-dimensional position (L1=(Lpx, Lpy, Lpz)) pointed by the laser pointer 50 can be obtained by the following formulae, where XYZ coordinates (X, Y, Z) of the tip of the laser pointer is defined as (Lpx, Lpy, Lpz):

Lpx=rₚ′×cos φ+X coordinate value of the coordinates Q

Lpy=rₚ′×sin φ+Y coordinate value of the coordinates Q

Lpz=rₚ′×sin θ

The Z coordinate of the tip of the laser pointer is a height r_{z} from the surface 10a, and can therefore be derived in the following manner by using a trigonometric function.

Lpz=rz=√ (rₚ²−rₚ′²)

The information of the peak coordinates and the peak received light intensity (sensing results) for a single scan obtained by the input signal calculation circuit 35 is temporarily stored in a memory (not shown) in the coordinate intensity storage circuit 34 (step S18). When the processes up to this point are completed, the process goes back to S11 to start processing the received light signals obtained in the subsequent scan of the sensor sequential scanning circuit 14.

Next, a method of detecting a temporal change of the laser pointer 50 will be explained below with reference to FIGS. 6 and 8. Here, as shown in FIG. 6, a case where the laser pointer 50 is moved to another location between the time of the first scan (t1) and the time of the second scan (t2) will be explained as an example.

First, in the first scan, the above-mentioned steps from S11 to S17 shown in FIG. 8 are performed, and the sensing results are stored in the memory (S18).

Next, in the second scan, the respective steps from S1 to S17 are repeated, and thereafter, in the comparison circuit 36, the information of the peak coordinates and the peak light intensity in the current scan (second scan), which is obtained by the input signal calculation circuit 35, and the information of the peak coordinates and the peak light intensity in the previous scan (first scan), which is stored in the memory, are compared, thereby determining whether the three-dimensional position of the laser pointer 50 has been changed (step S19). That is, the comparison circuit 36 respectively derives a change Δx in the horizontal direction (X axis direction), a change Δy in the front and back direction (Y axis direction), and a change Δz (z1−z2) in the vertical direction (Z axis direction) of the laser pointer 50 between the time t1 and the time t2 (see FIG. 6).

This way, the change in the three-dimensional positions (L1→L2) of the laser pointer 50 between the time (t1) and the time (t2) is determined. That is, the temporal change in the three-dimensional position of the laser pointer 50 can be measured.

By performing the above-mentioned processes, the input position detection system 1 of this embodiment can detect not only the position on the XY coordinate plane that is pointed by the laser pointer 50, but also the distance between the laser pointer 50 and the image display surface (that is, the Z coordinate of the laser pointer 50). Also, the input position detection system 1 of this embodiment detects the input position of the input pointer by using the area sensor made of the respective optical sensor elements 30 arranged in a matrix so as to correspond to the image display surface of the liquid crystal panel 20. This makes it possible to detect the input position of the input pointer in close relation to the position of a displayed image, thereby improving an accuracy of the three-dimensional pointing as compared with the non-contact pointing device of Patent Document 2.

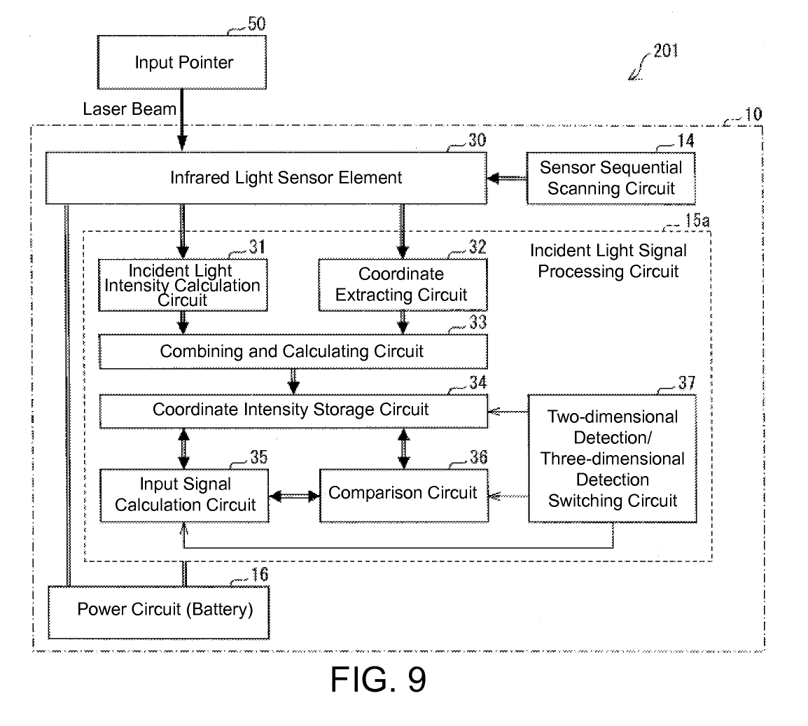

The input position detection system 1 of the present invention may be provided with a function of performing conventional two-dimensional (planar) position detection, in addition to the above-mentioned function of performing the three-dimensional position detection. FIG. 9 shows a configuration of an input position detection system 201 that is capable of both the three-dimensional position detection and the two-dimensional position detection. In a manner similar to the input position detection system 1, the input position detection system 201 is constituted of the laser pointer 50 and the liquid crystal display device 10.

As shown in FIG. 9, a received light signal processing circuit 15a in the liquid crystal display device 10 includes a two-dimensional detection/three-dimensional detection switching circuit 37 (two-dimension/three-dimension switching unit), in addition to the respective components included in the received light signal processing circuit 15 (see FIG. 1). The three-dimensional position detection in the input position detection system 201 is performed in a manner similar to the input position detection system 1.

On the other hand, when the detection mode is changed from the three-dimensional detection mode to the two-dimensional detection mode by the two-dimensional detection/three-dimensional detection switching circuit 37, the coordinate intensity storage circuit 34, the input signal calculation circuit 35, and the comparison circuit 36 perform different processes from those of the three-dimensional detection mode.

Specifically, the input signal calculation circuit 35 performs a calculation for determining the position on the coordinate plane where the intensity of the received light reaches the peak and whether the peak intensity exceeds a threshold or not, based on information stored in the coordinate intensity storage circuit 34. This threshold is a value used as a reference in determining presence or absence of an input by the laser pointer 50. When the peak intensity exceeds the threshold, the position on the XY coordinate plane having the peak intensity is defined as the input position on the XY plane. In the two-dimensional detection mode, the input signal calculation circuit 35 does not perform a process of deriving a Z coordinate of the laser pointer 50 based on the received light intensity.

When the two-dimensional detection mode is selected, there is no need to compare the previous sensing results and the current sensing results, and therefore, the comparison circuit 36 does not perform a process. Further, the memory in the coordinate intensity storage circuit 34 does not perform a primary storage operation of the sensing results.

Except for the configurations described above, the input position detection system 201 can be configured in a manner similar to the input position detection system 1, and therefore, the explanation thereof is omitted.

In this embodiment, the liquid crystal display device with the integrated area sensor, in which an area sensor function is provided by the optical sensor elements that are incorporated in the liquid crystal panel, has been explained as an example, however, the present invention is not necessarily limited to such a configuration. That is, a liquid crystal display device with an area sensor function, in which an area sensor and a liquid crystal panel are prepared as separate units, and are stacked such that the area sensor overlaps an image display surface of the liquid crystal panel, is also one of the examples of the present invention. The display panel is not limited to a liquid crystal display panel, and light-emitting display panels such as a plasma display panel (PDP) and an organic EL panel may also be used.

### Embodiment 2

Embodiment 2 of the present invention will be explained below. In this embodiment, an input position detection system 301 allowing for a multi-point input to a liquid crystal display device 10 by using a plurality of laser pointers (50a and 50b) will be explained.

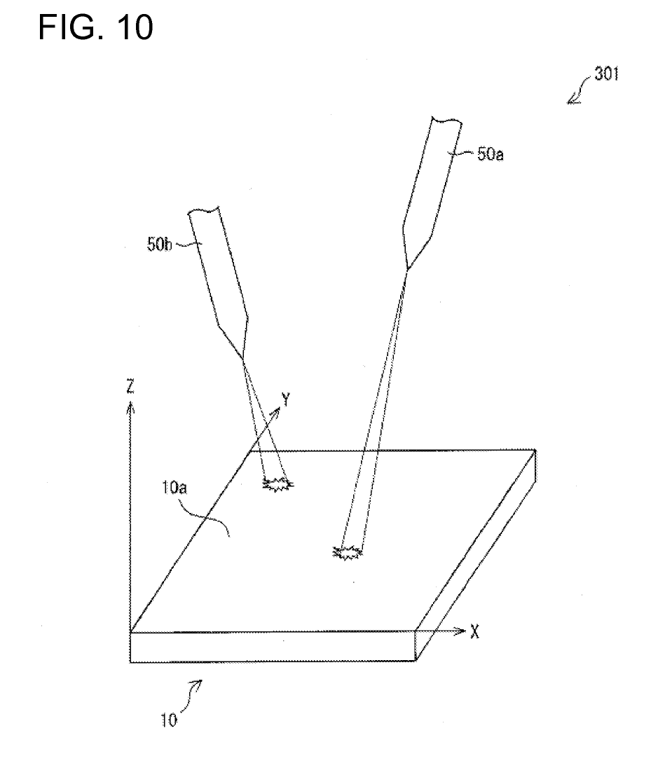

FIG. 10 is a schematic view of the input position detection system 301 of this embodiment that is performing the three-dimensional position detection. As shown in FIG. 10, in the input position detection system 301, two laser pointers 50a and 50b (input pointers) are provided for a single liquid crystal display device 10.

Configurations of the respective laser pointers 50a and 50b are the same as the configuration of the laser pointer 50 of Embodiment 1, and therefore, the explanation thereof is omitted. The liquid crystal display device 10 can be configured in the substantially same manner as the liquid crystal display device 10 of Embodiment 1, and therefore, the detailed explanation thereof is omitted, and only the points that differ from Embodiment 1 will be explained. Explanations of a flow of the position detection process will also be made only for the points that differ from Embodiment 1.

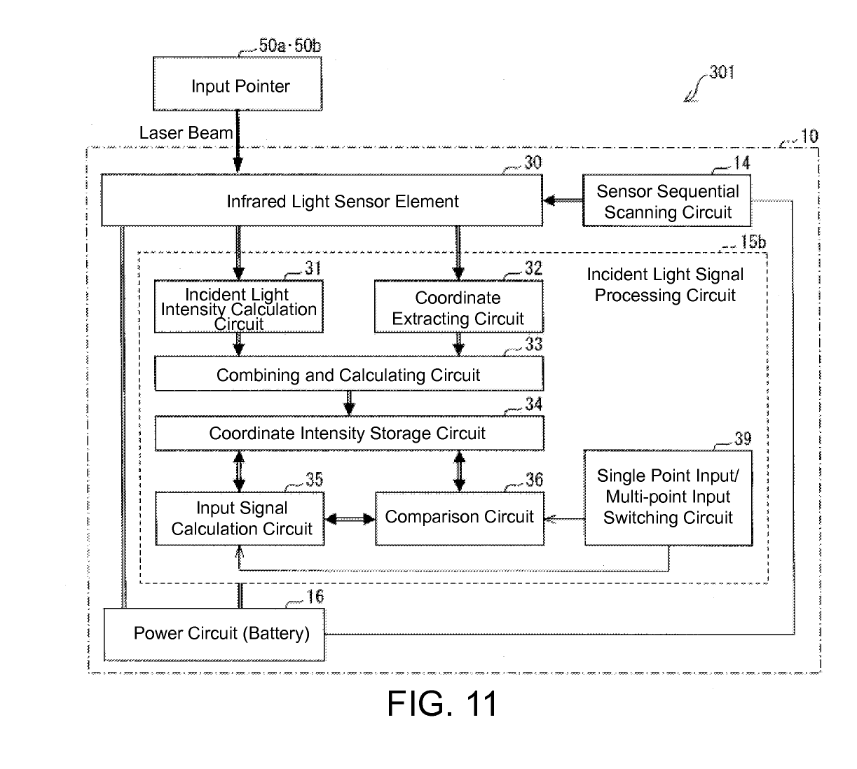

FIG. 11 shows a configuration of the input position detection system 301. The input position detection system 301 includes two laser pointers 50a and 50b and the liquid crystal display device 10.

As shown in FIG. 11, a received light signal processing circuit 15b in the liquid crystal display device 10 includes a single point input/multi-point input switching circuit 39, in addition to the respective components included in the received light signal processing circuit 15 (see FIG. 1). The single point input/multi-point input switching circuit 39 is a circuit that switches the input mode between the single point input mode and the multi-point input mode.

Except for the single point input/multi-point input switching circuit 39, the input position detection system 301 can be configured in a manner similar to the input position detection system 1, and therefore, the explanations thereof is omitted.

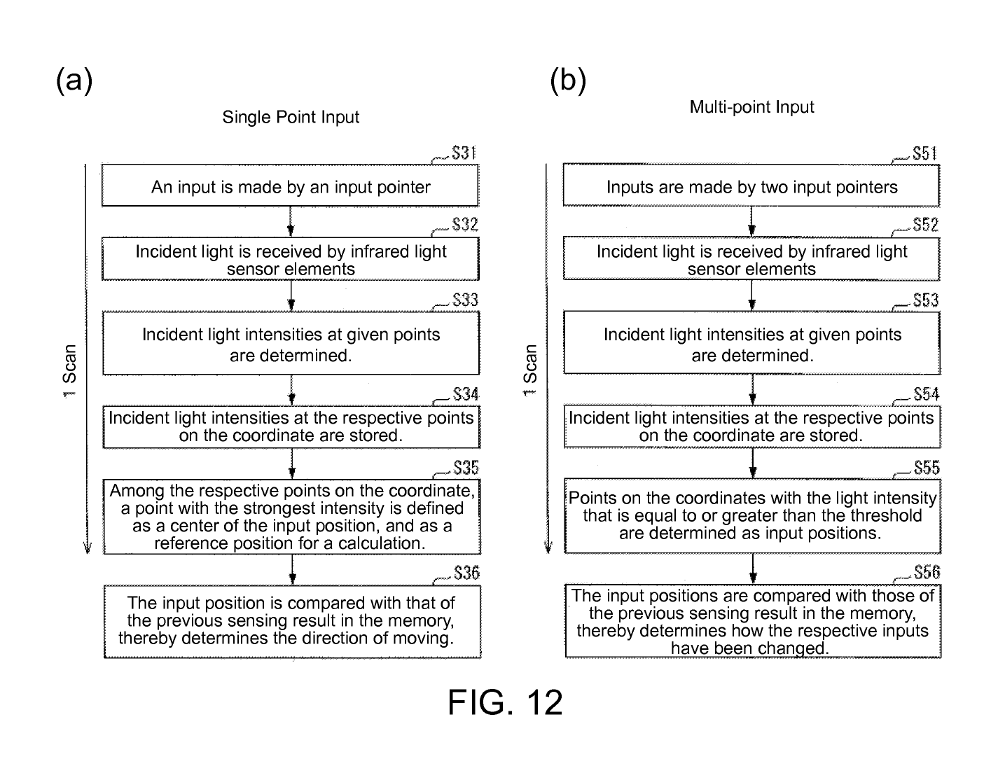

FIG. 12(a) illustrates a flow of the three-dimensional position detection process when the single point input is performed in the input position detection system 301. FIG. 12(b) illustrates a flow of the three-dimensional position detection process when the multi-point input is performed in the input position detection system 301.

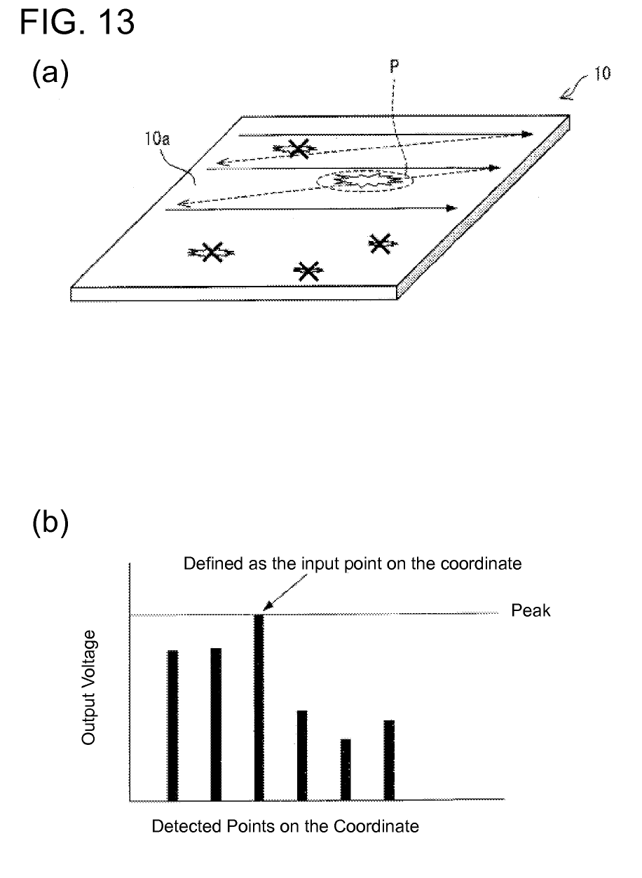

FIG. 13(a) illustrates a position detection scheme in the input position detection system 301 when the single point input is performed. FIG. 13(b) illustrates a method of detecting the input position in the input position detection system 301 when the single point input is performed.

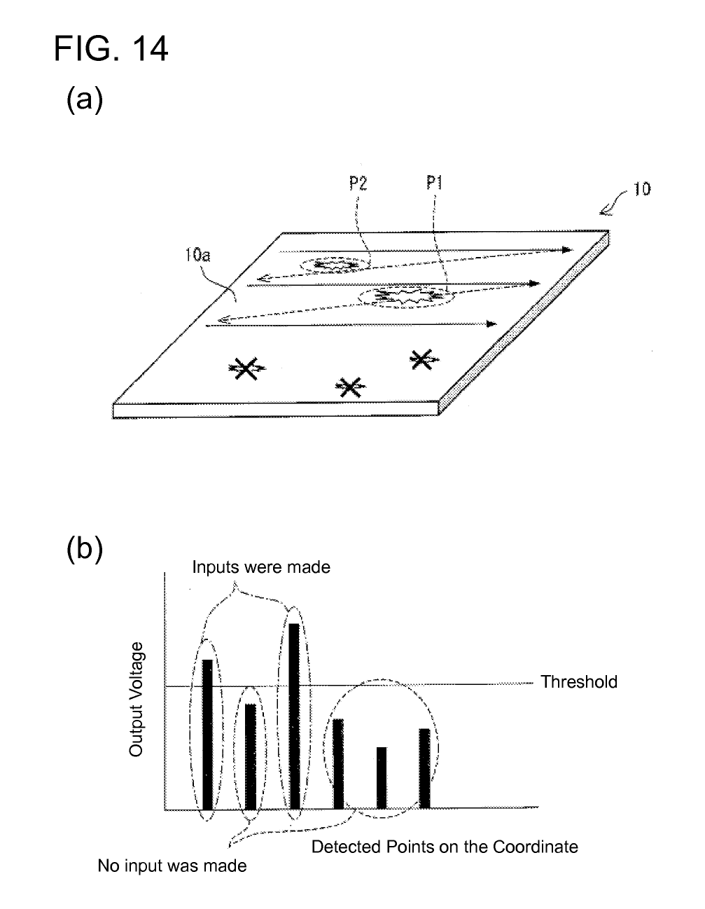

FIG. 14(a) illustrates a position detection scheme in the input position detection system 301 when the multi-point input is performed. FIG. 14(b) illustrates a method of detecting the input position in the input position detection system 301 when the multi-point input is performed.

When the single point input mode is selected by the single point input/multi-point input switching circuit 39 (single point/multi-point switching unit), the process is performed in accordance with the process flow shown in FIG. 12(a).

Specifically, when a laser beam (infrared light) is emitted to the surface 10a of the liquid crystal display device 10 from one laser pointer 50a at a given point in time, the liquid crystal display device 10 receives an input by the laser pointer 50a (step S31). At this time, in the liquid crystal display device 10, a sensing operation is performed by the respective optical sensor elements 30 (infrared light sensor elements) that are sequentially selected by the sensor sequential scanning circuit 14, and received light signals are generated based on an amount of infrared light that has been emitted (step S32). The received light signals of the respective optical sensor elements 30 obtained in each scan of the sensor sequential scanning circuit 14 are sent to the received light signal processing circuit 15b sequentially.

In the received light signal processing circuit 15b, first, the received light intensity calculation circuit 31 derives the intensities of the received infrared light based on the received light signals that have been provided. Simultaneously with this step, the coordinate extracting circuit 32 determines coordinate positions from which the respective received light signals were sent in accordance with a scan of the sensor sequential scanning circuit 14.

Subsequently, the combining and calculating circuit 33 combines the calculation results of the infrared intensities in the received light intensity calculation circuit 31 and the coordinate positions determined by the coordinate extracting circuit 32, and determines the intensities of infrared light at respective coordinate positions (step S33). The coordinate intensity storage circuit 34 receives the intensities of light received by the respective optical sensor elements 30, which were derived by the combining and calculating circuit 33, and stores the received light intensities at the respective coordinate positions (step S34).

Thereafter, the input signal calculation circuit 35 derives, based on the information stored in the coordinate intensity storage circuit 34, the position where the light having the highest intensity was received among the respective positions on the coordinate, and defines that position as the center of the input position, which will be used as a reference position of the calculation. That is, the input signal calculation circuit 35 performs a calculation to determine the coordinate position with the peak intensity and the level of the peak intensity (step S35), and thereafter defines the position on the XY coordinate plane having the peak intensity as the input position on the XY plane. A distance of the laser pointer 50a (i.e., z coordinate of the laser pointer 50a) from the surface 10a of the liquid crystal display device 10 is derived by referring to a reference table in which distances from the detection target surface 10a are correlated to received light intensities at the respective distances.

The respective processes from the step S31 through the step S35 are performed for every single scan conducted by the sensor sequential scanning circuit 14, and with the step S35, the three-dimensional position of the laser pointer 50 at a given point in time is determined. The method of determining the three-dimensional position is similar to that of Embodiment 1.

The information of the peak coordinates and the peak light intensity (sensing results) for a single scan obtained by the input signal calculation circuit 35 is temporarily stored in a memory (not shown) in the coordinate intensity storage circuit 34, and the process goes back to S31 to start processing the received light signals obtained in the subsequent scan.

Next, in the second scan, the respective steps from S31 to S35 are repeated, and thereafter, the comparison circuit 36 compares the information of the peak coordinates and the peak light intensity in the current scan (second scan), which was obtained by the input signal calculation circuit 35, with the information of the peak coordinates and the peak light intensity in the previous scan (first scan), which is stored in the memory, thereby determining whether the three-dimensional position of the laser pointer 50 has been changed (step S36). This process is also performed in the same manner as Embodiment 1.

The position detection in the single point input mode is performed in accordance with the above-mentioned process flow, and as shown in FIG. 13(b), the coordinate position having the highest output voltage among the respective coordinate positions is determined as the peak, which is detected as the input position P (see FIG. 13(a)). As shown in FIG. 13(a), when infrared light having a prescribed intensity is detected at other positions on the coordinate than the peak position, it is cancelled as noise.

On the other hand, when the detection mode is changed from the single point input mode to the multi-point input mode by the single point input/multi-point input switching circuit 39, the input signal calculation circuit 35 and the comparison circuit 36 perform different processes from those of the single point mode.

That is, the steps from S51 to S54 in the flowchart shown in FIG. 12(b) are performed in a manner similar to the steps S31 to S34 in the flowchart shown in FIG. 12(a), and in the subsequent steps, different processes from those of the single point input mode are performed.

Specifically, the input signal calculation circuit 35 performs a calculation to determine the coordinate position where the intensity of the received light reaches the peak and whether the peak intensity exceeds a threshold or not, based on information stored in the coordinate intensity storage circuit 34. This threshold is a value used as a reference in determining presence or absence of an input by the laser pointers 50. As shown in FIG. 14(b), when the output voltage that exceeds the threshold is detected at a plurality of coordinate positions, it is determined that inputs were made at these respective coordinate positions (step S55). The input signal calculation circuit 35 thereafter defines respective positions on the XY coordinate plane that correspond to the positions having the peak intensity greater than the threshold as the input positions on the XY plane. The respective distances between the laser pointers 50a and 50b and the surface 10a of the liquid crystal display device 10 at the respective positions where the inputs were detected (that is, Z coordinates of the laser pointers) are derived in a manner similar to Embodiment 1.

The respective processes in the steps from S51 to S55 are performed for every single scan of the sensor sequential scanning circuit 14, and with the step S55, respective three-dimensional positions of the laser pointers 50a and 50b at a given point in time are determined.

The information of the peak coordinates and the peak light intensity (sensing results) of the respective laser pointers 50a and 50b in a single scan obtained by the input signal calculation circuit 35 is temporarily stored in a memory (not shown) in the coordinate intensity storage circuit 34, and the process goes back to S51 to start processing the received light signals obtained in the subsequent scan.

Next, in the second scan, the respective steps from S51 to S55 are repeated, and thereafter, the comparison circuit 36 compares the information of the coordinate positions and the received light intensities of the respective laser pointers 50a and 50b in the current scan (second scan), which was obtained by the input signal calculation circuit 35, with the information of the coordinate positions and the received light intensities of the respective laser pointers 50a and 50b in the previous scan (first scan), which is stored in the memory, thereby determining whether the three-dimensional positions of the laser pointers 50 have been changed (step S56).

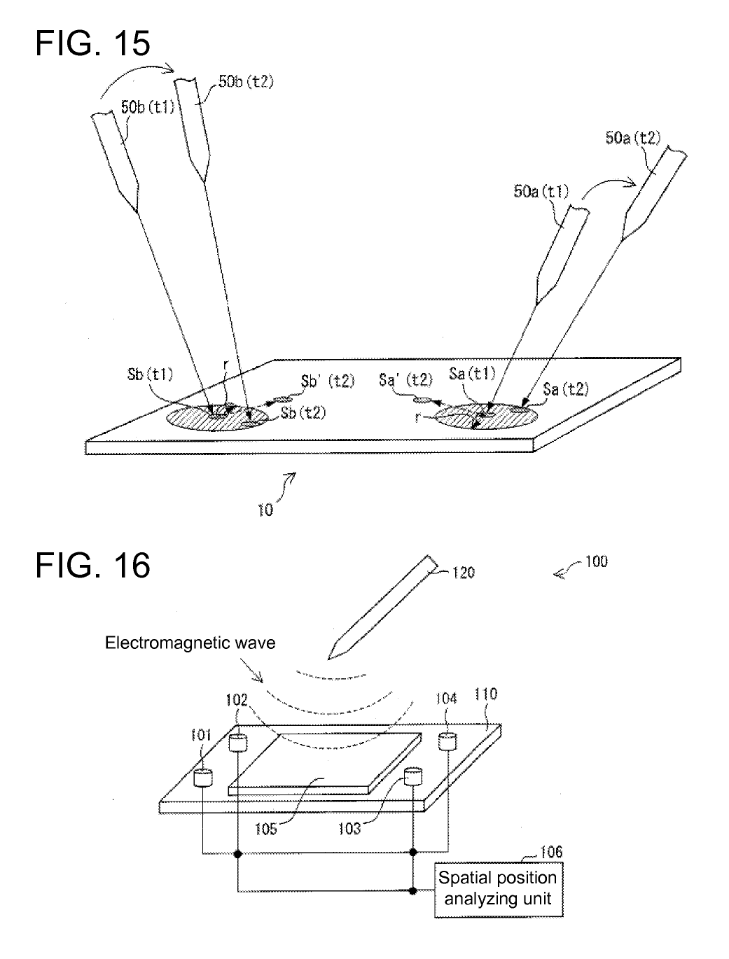

Below, a method of detecting temporal change of each laser pointer when there are a plurality of laser pointers will be explained with reference to FIG. 15.

In this method, coordinate positions (Sa(t1)·Sb(t1)) of the respective laser pointers 50a and 50b, which were obtained in the previous sensing, are recorded and compared with coordinate positions (Sa(t2)·Sb(t2)), which were obtained in the current sensing, thereby determining the respective differences. In FIG. 15, the previous sensing is represented by t1, and the current sensing is represented by t2. The coordinate position of the laser pointer 50a obtained in the previous sensing is represented by Sa(t1), and the coordinate position obtained in the current sensing is represented by Sa(t2) or Sa′(t2). The coordinate position of the laser pointer 50b obtained in the previous sensing is represented by Sb(t1), and the coordinate position obtained in the current sensing are represented by Sb(t2) or Sb′(t2).

When the respective coordinate positions (Sa(t2)·Sb(t2)) that are detected in the current sensing are present within a prescribed area (within an area of a circle having a radius “r” (a region indicated by hatching in FIG. 15), for example) from the respective coordinate positions (Sa(t1)·Sb(t1)) that were detected in the previous sensing, it is determined that the respective laser pointers 50a and 50b were moved to these coordinate positions between the previous sensing to the current sensing.

On the other hand, when the coordinate positions (Sa′(t2)·Sb'(t2)) that are detected in the current sensing are not present within a prescribed area (within an area of a circle having a radius “r” (a region indicated by hatching in FIG. 15), for example) from the coordinate positions (Sa(t1)·Sb(t1)) that were detected in the previous sensing, it is determined that, between the previous sensing to the current sensing, the respective laser pointers 50a and 50b were not moved, but instead, an new input was made by another laser pointer.

This way, even when there are a plurality of laser pointers, it becomes possible to detect positional changes of the respective laser pointers.

The position detection in the multi-point input mode is performed in accordance with the process flow described above, and as shown in FIG. 14(b), among the respective coordinate positions, the positions having an output voltage that exceeds the threshold are determined as input positions, and therefore, the input positions P1 and P2 are detected (see FIG. 14(a)). As described, in the multi-point input mode, when output voltages exceed the threshold at a plurality of coordinate positions, all of these points are detected as input positions.

The present invention is not limited to the above-mentioned embodiments, and various modifications can be made without departing from the scope specified by the claims. Other embodiments obtained by appropriately combining the techniques that have been respectively described in the above-mentioned embodiments are included in the technical scope of the present invention.

In order to solve the above-mentioned problems, a display device according to the present invention has a position detection function capable of detecting light that is output from an input pointer and thereby detects an input position by the input pointer, including: a plurality of optical sensor elements disposed in a matrix so as to correspond to an image display surface of the display device; a plane coordinate detecting unit that detects positions on an array of the respective optical sensor elements disposed in a matrix where an input from the input pointer was received, a received light intensity detecting unit that detects intensities of light received by the optical sensor elements, a coordinate and intensity combining unit that derives intensities of received light at given coordinate positions by combining the positions on a coordinate plane where the input was received, which were obtained by the plane coordinate detecting unit, and the intensities of light received on the coordinate plane, which were obtained by the received light intensity detecting unit; and a input position detecting unit that “detects the three-dimensional input position of the input pointer” by calculating a distance of the input pointer from the image display surface based on information regarding the received light intensity obtained by the coordinate and intensity combining unit.

“Detects the three-dimensional input position of the input pointer” means detecting the input position of the input pointer on a plane where the optical sensor elements are disposed in a matrix, and detecting how far the input pointer is located from the plane, i.e., a distance between the input pointer and the optical sensor elements. That is, it means detecting the position that is pointed by the input pointer in a space coordinate system (XYZ space coordinate system, for example).

According to this configuration, the coordinate and intensity combining unit combines the positions on the coordinate plane where the input was received, which was obtained by the plane coordinate detecting unit, with the intensities of the received light detected on the coordinate plane, which was obtained by the received light intensity detecting unit, thereby deriving the intensities of received light at given coordinate positions. The input position detecting unit calculates a distance of the input pointer from the image display surface based on the information of the received light intensity that was obtained by the coordinate and intensity combining unit. This makes it possible not only to detect the position on the coordinate plane that is pointed by the input pointer, but also to detect the distance between the input pointer and the image display surface, and as a result, the position of an input from the input pointer can be detected three-dimensionally.

According to the above-mentioned configuration, the input position is detected by using an area sensor that is made of the respective optical sensor elements arranged in a matrix so as to correspond to the image display surface. This makes it possible to detect the input position of the input pointer in relation to the position of a displayed image, which allows for three-dimensional pointing with a higher degree of accuracy

In the display device according to the present invention, the optical sensor elements may be infrared light sensor elements that can detect infrared light.

In the display device according to the present invention, the input position detecting unit may calculate a distance of the input pointer from the image display surface by referring to a reference data, in which a relationship between the received light intensity and the distance of the input pointer from the image display surface is stored.

According to this configuration, the distance of the input pointer from the image display surface can be derived based on the received light intensity with a simple calculation process.

Alternatively, the input position detecting unit may calculate a distance of the input pointer from the image display surface by using a function that has been obtained in advance based on a relationship between the distances of the input pointer from the image display surface and the received light intensities detected for the respective distances.

According to this configuration, the distance of the input pointer from the image display surface can be derived based on the received light intensity with a simple calculation process.

The display device according to the present invention may further includes a storage unit that stores positional information of the input pointer obtained in the previous position detection and positional information of the input pointer obtained in the current position detection, and a positional change calculating unit that calculates a temporal change in the positions of the input pointer by comparing the positional information of the input pointer obtained in the current position detection with the positional information of the input pointer obtained in the previous position detection.

According to this configuration, the change in the three-dimensional positions of the input pointer can be obtained as a temporal change.

The display device according to the present invention may further includes a two-dimension/three-dimension switching unit that switches a detection mode between a two-dimensional detection mode for “detecting an input position of the input pointer two-dimensionally” and a three-dimensional detection mode for detecting an input position of the input pointer three-dimensionally, and when the two-dimensional detection mode is selected by the two-dimension/three-dimension switching unit, the input position detecting unit may not perform a calculation to obtain a distance of the input pointer from the image display surface.

Here, “detecting an input position of the input pointer two-dimensionally” means detecting, on a plane where the optical sensor elements are arranged in a matrix, a position to which the input pointer made an input. That is, it means detecting the coordinate position on the coordinate plane (XY coordinate plane, for example), which is pointed by the input pointer.

This configuration allows a single display device to selectively perform both of the two-dimensional detection and the three-dimensional detection.

In the display device according to the present invention, the input position detecting unit may determine a position where the received light intensity that is equal to or greater than the threshold was detected by the received light intensity detecting unit as an input position.

According to this configuration, a plurality of positions having the received light intensity that is equal to or greater than the threshold are detected as input positions. Therefore, with this configuration, it becomes possible to achieve the multi-point input that is performed by using a plurality of input pointers.

In the display device according to the present invention, the input position detecting unit may determine a position where the highest received light intensity was detected by the received light intensity detecting unit as an input position.

According to this configuration, even when light with a certain degree of intensity was received at a plurality of positions, only a single point having the highest received light intensity is detected as an input position. Therefore, even when low-intensity light that is not emitted from the input pointer is incident on the display device for some reason, an erroneous detection of an input position can be prevented.

The display device according to the present invention further includes a single point/multi-point switching unit that switches an input mode between a single point input mode in which an input position of a single input pointer is detected and a multi-point input mode in which input positions of a plurality of input pointers are detected, and when the single point input mode is selected by the single point/multi-point switching unit, the input position detecting unit may determine a position where the highest intensity was detected by the received light intensity detecting unit as an input position. On the other hand, when the multi-point input mode is selected by the single point/multi-point switching unit, the input position detecting unit may determine positions where the intensity that is equal to or greater than the threshold was detected by the received light intensity detecting unit as input positions.

This configuration allows a single display device to selectively perform both of the single point input and the multi-point input.

In order to solve the above-mentioned problems, an input position detection system according to the present invention includes the display device of the present invention and an input pointer that performs an input by emitting light to the display device.

The input position detection system according to the present invention includes the display device having any one of the above-mentioned configurations, which allows for a three-dimensional position detection with a higher degree of accuracy.

In order to solve the above-mentioned problems, the input position detection system according to the present invention includes the display device of the present invention and the input pointer that performs an input by emitting light to the display device, wherein the input pointer is provided with an infrared light output unit.

In order to solve the above-mentioned problems, the input position detection system according to the present invention includes the display device of the present invention and a plurality of input pointers that respectively perform an input by emitting light to the display device.

According to this configuration, it becomes possible to perform the multi-point input by using the plurality of input pointers.

The specific embodiments or examples described in the detailed explanation of the present invention are merely for an illustration of the technical contents of the present invention. The present invention shall not be narrowly interpreted by being limited to such specific examples. Various changes can be made within the spirit of the present invention and the scope as defined by the appended claims.

### INDUSTRIAL APPLICABILITY

The input position detection system according to the present invention makes it possible to detect a three-dimensional input position. Therefore, the present invention can be used for a system that makes an input performs an input to an image display device that displays a stereoscopic image, for example.

### DESCRIPTION OF REFERENCE CHARACTERS

1 (201, 301) input position detection system

14 sensor sequential scanning circuit

15 (15a, 15b) received light signal processing circuit

10 liquid crystal display device (display device)

30 optical sensor element

31 received light intensity calculation circuit (received light intensity detecting unit)

32 coordinate extracting circuit (plane coordinate detecting unit)

33 combining and calculating circuit (coordinate and intensity combining unit)

34 coordinate intensity storage circuit

35 input signal calculation circuit (input position detecting unit)

36 comparison circuit (positional change deriving unit)

37 two-dimensional detection/three-dimensional detection switching circuit (two-dimension/three-dimension switching unit)

39 single point input/multi-point input switching circuit (single point/multi-point switching unit)

50 (50a, 50b) laser pointer (input pointer)

1. A display device that has a position detection function capable of detecting light that is output from an input pointer and thereby detects an input position by the input pointer, comprising:
a plurality of optical sensor elements disposed in a matrix so as to correspond to an image display surface of the display device;
a plane coordinate detecting unit that detects positions on an array of the respective optical sensor elements disposed in a matrix where an input from the input pointer was received;
a received light intensity detecting unit that detects intensities of light received by the optical sensor elements;
a coordinate and intensity combining unit that derives intensities of the received light at respective coordinate positions by combining the positions on a coordinate plane where the input was received, which were obtained by the plane coordinate detecting unit, and the intensities of light received on the coordinate plane, which were obtained by the received light intensity detecting unit; and
an input position detecting unit that detects an input position of the input pointer three-dimensionally by calculating a distance of the input pointer from the image display surface based on information of the received light intensities obtained by the coordinate and intensity combining unit.

2. The display device according to claim 1, wherein the optical sensor elements are infrared light sensor elements that can detect infrared light.

3. The display device according to claim 1, wherein the input position detecting unit calculates a distance of the input pointer from the image display surface by referring to a reference data, in which a relationship between a received light intensity and a distance of the input pointer from the image display surface is stored.

4. The display device according to claim 1, wherein the input position detecting unit calculates a distance of the input pointer from the image display surface by using a function that has been obtained in advance based on a relationship between respective distances of the input pointer from the image display surface and received light intensities detected for the respective distances.

5. The display device according to claim 1, further comprising:
a storage unit that stores positional information of the input pointer obtained in a previous position detection period and positional information of the input pointer obtained in a current position detection period; and
a positional change calculating unit that calculates a temporal change of positions of the input pointer by comparing the positional information of the input pointer obtained in the current position detection period with the positional information of the input pointer obtained in the previous position detection period.

6. The display device according to claim 1, further comprising:
a two-dimension/three-dimension switching unit that switches a detection mode between a two-dimensional detection mode for detecting an input position of the input pointer two-dimensionally and a three-dimensional detection mode for detecting an input position of the input pointer three-dimensionally,
wherein, when the two-dimensional detection mode is selected by the two-dimension/three-dimension switching unit, the input position detecting unit does not perform a calculation to obtain a distance of the input pointer from the image display surface.

7. The display device according to claim 1, wherein the input position detecting unit determines a position where a received light intensity that is equal to or greater than a threshold was detected by the received light intensity detecting unit as an input position.

8. The display device according to claim 1, wherein the input position detecting unit determines a position where a highest received light intensity was detected by the received light intensity detecting unit as an input position.

9. The display device according to claim 1, further comprising:
a single point/multi-point switching unit that switches an input mode between a single point input mode in which an input position of a single input pointer is detected and a multi-point input mode in which input positions of a plurality of input pointers are detected,
wherein, when the single point input mode is selected by the single point/multi-point switching unit, the input position detecting unit determines a position where a highest intensity was detected by the received light intensity detecting unit as an input position, and
when the multi-point input mode is selected by the single point/multi-point switching unit, the input position detecting unit determines positions where an intensity that is equal to or greater than the threshold was detected by the received light intensity detecting unit as input positions.

10. An input position detection system, comprising:
the display device according to claim 1; and
an input pointer that performs an input by emitting light to the display device.

11. An input position detection system, comprising:
the display device according to claim 2; and
an input pointer that performs an input by emitting light to the display device,
wherein the input pointer is provided with an infrared light output unit.

12. An input position detection system, comprising:
the display device according to claim 7; and
a plurality of input pointers that respectively perform inputs by emitting light to the display device.
